(19) United States
(12) Patent Application Publication
(10) Pub. No.: US 2026/0005604 A1
(43) Pub. Date: Jan. 1, 2026

(54) SWITCHING CONVERTER WITH PRE-CHARGE CIRCUIT

(71) Applicant: Monolithic Power Systems, Inc., Kirkland, WA (US)

(72) Inventors: Ting Ge, San Jose, CA (US); Eric Nguyen, Bellevue, WA (US)

(21) Appl. No.: 18/756,602

(22) Filed: Jun. 27, 2024

(51) Int. Cl. H02M 3/07; H02M 1/32

(52) U.S. Cl. CPC H02M 3/07; H02M 1/32

(57) ABSTRACT

A switching converter has an input terminal, an output terminal, a switching circuit, a flying capacitor, and a pre-charge circuit. The input terminal receives an input voltage, the output terminal provides an output voltage. The switching circuit has a plurality of switch devices. The flying capacitor is coupled between at least two of the plurality of switch devices. The pre-charge circuit charges the flying capacitor via partially turning on a pre-charge switch during start-up of the switching converter. A first terminal of the pre-charge switch is coupled to the input terminal. A voltage at a second terminal of the pre-charge switch is controlled to follow a voltage at a control terminal of the pre-charge switch, and a voltage across the flying capacitor is controlled to increase when the input voltage increases.

### BACKGROUND OF THE INVENTION

### 1. Field of the Invention

The present invention generally relates to electronic circuits, and more particularly but not exclusively relates to switching converters.

### 2. Description of Related Art

Recently, with emergence of high-performance processors, switching converters with smaller output voltage and larger output current are needed, with higher requirements on energy conversion efficiency. In some applications, such as switched capacitor converters and multi-level switching converters, a flying capacitor is employed to store and release energy, to complete energy transmission and voltage conversion together with switch devices, so as to achieve high power density and small size.

However, during start-up of the switching converter, an initial voltage across the flying capacitor is zero or is much lower than that at steady state. As a result, some of the switch devices suffer from high voltage stress during start-up and may be damaged.

### SUMMARY OF THE INVENTION

It is one of the objects of the present invention to provide a switching converter and a pre-charge method of the switching converter.

One embodiment of the present invention discloses a switching converter having an input terminal, an output terminal, a switching circuit, a first flying capacitor, an output filter, and a pre-charge circuit. The input terminal is configured to receive an input voltage. The output terminal configured to provide an output voltage. The switching circuit has a first switch device, a second switch device, and a third switch device. A first terminal of the first switch device is coupled to the input terminal, and a first terminal of the second switch device is coupled to a second terminal of the first switch device. A first terminal of the first flying capacitor is coupled to the first terminal of the second switch device and the second terminal of the first switch device, and a second terminal of the flying capacitor is coupled to a first terminal of the third switch device. The output filter is coupled between the switching circuit and the output terminal, and the output filter comprises a magnetic device coupled to a second terminal of the second switch device. The pre-charge circuit is coupled to the input terminal, and is configured to charge the first flying capacitor via a first pre-charge switch during start-up of the switching converter. The first pre-charge switch has a first terminal coupled to the input terminal, a second terminal and a control terminal. The pre-charge circuit is configured to get a voltage at the second terminal of the first pre-charge switch to follow a voltage at the control terminal of the first pre-charge switch during start-up of the switching converter.

Another embodiment of the present invention discloses a switching converter having an input terminal, an output terminal, a switching circuit, a flying capacitor, and a pre-charge circuit. The input terminal is configured to receive an input voltage. The output terminal is configured to provide an output voltage. The switching circuit has a plurality of switch devices. The flying capacitor is configured to be coupled between at least two of the plurality of switch devices. The pre-charge circuit is configured to charge the flying capacitor via partially turning on a pre-charge switch during start-up of the switching converter. The pre-charge switch has a first terminal coupled to the input terminal, a second terminal and a control terminal. During start-up of the switching converter, a voltage at the second terminal of the pre-charge switch is controlled to follow a voltage at the control terminal of the pre-charge switch, and a voltage across the flying capacitor is configured to increase when the input voltage increases.

Yet another embodiment of the present invention discloses a pre-charge method for a switching converter. Receiving an input voltage at an input terminal and providing an output voltage at an output terminal. Coupling a pre-charge switch between the input terminal and a first terminal of a flying capacitor such that the flying capacitor is capable of being charged by the pre-charge switch during start-up of the switching converter. The pre-charge switch has a first terminal coupled to the input terminal, a second terminal and a control terminal. Couping a gate control cirucit to the input terminal, wherein the gate control circuit is configured to provide a gate control signal to control the pre-charge switch. Partially turning on the pre-charge switch via the gate control circuit to charge the flying capacitor during start-up of the switching converter, such that a voltage at the second terminal of the pre-charge switch is capable of following a voltage at the control terminal of the pre-charge switch.

These and other features of the present invention will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically illustrates a switching converter 100 in accordance with an embodiment of the present invention.

FIG. 2 schematically illustrates a switching converter 200 in accordance with an embodiment of the present invention.

FIG. 3 schematically illustrates a switching converter 300 in accordance with an embodiment of the present invention.

FIG. 4 illustrates a timing diagram 400 of the switching converter 300 shown in FIG. 3 in accordance with an embodiment of the present invention.

FIG. 5 schematically illustrates a switching converter 500 in accordance with an embodiment of the present invention.

FIG. 6 schematically illustrates a switching converter 600 in accordance with an embodiment of the present invention.

FIG. 7 schematically illustrates a switching converter 700 in accordance with an embodiment of the present invention.

FIG. 8 schematically illustrates a switching converter 800 in accordance with an embodiment of the present invention.

FIG. 9 illustrates a pre-charge method 900 of a switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

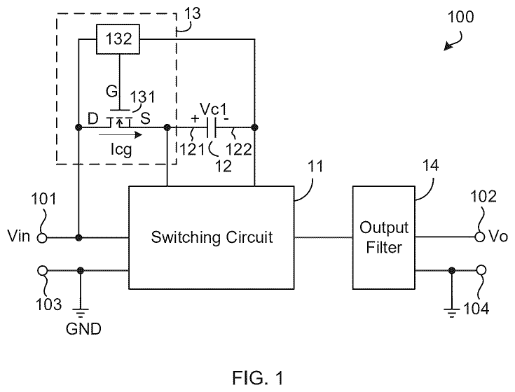

FIG. 1 schematically illustrates a switching converter 100 in accordance with an embodiment of the present invention. The switching converter 100 has an input terminal 101, an input return terminal 103, an output terminal 102, and an output return terminal 104. The input terminal 101 is configured to receive an input voltage Vin, and the output terminal 102 is configured to provide an output voltage Vo. The input return terminal 103 and the output return terminal 104 are coupled to a reference ground GND.

As shown in FIG. 1, the switching converter 100 comprises a switching circuit 11, a flying capacitor 12, and a pre-charge circuit 13. The switching circuit 11 has a plurality of switch devices. In one embodiment, a first group of the plurality of switch devices and a second group of the plurality of switch devices are configured to be turned on and off alternately. The flying capacitor 12 is coupled to the switching circuit 11, e.g., to store and release energy. In one embodiment, the flying capacitor 12 is coupled between at least two of the plurality of switch devices, to store and release energy alternately (e.g., after start-up of the switching converter 100 is complete). The pre-charge circuit 13 is coupled between the input terminal 101 and the flying capacitor 12, to charge the flying capacitor 12 via partially turning on a pre-charge switch 131 during start-up of the switching converter 100, such that a voltage Vc1 across the flying capacitor 12 increases when the input voltage Vin increases. In one embodiment, start-up of the switching converter 100 comprises that the input voltage Vin increases from an initial input voltage value to a nominal input voltage value. In one embodiment, partially turning on the pre-charge switch 131 comprises controlling the pre-charge switch 131 to operate in a linear mode. In one embodiment, the pre-charge circuit 13 is further configured to automatically stop charging the flying capacitor 12 based on the input voltage Vin. For instance, the pre-charge circuit 13 stops charging the flying capacitor 12 when the input voltage Vin has increased to the nominal input voltage value such that start-up of the switching converter 100 is complete and the switching converter 100 enters normal operation.

The pre-charge switch 131 may comprise Bipolar Junction Transistor (BJT), Metal Oxide Semiconductor Field Effect Transistor (MOSFET), and other suitable transistors. In one embodiment, the pre-charge switch 131 has a first terminal (e.g., a drain terminal D), a second terminal (e.g. a source terminal S), and a control terminal (e.g., a gate terminal G). The first terminal of the pre-charge switch 131 is coupled to the input terminal 101, the second terminal of the pre-charge switch 131 is coupled to a terminal 121 of the flying capacitor 121 to charge the flying capacitor 121. In another embodiment, one of the plurality of switch devices of the switching circuit 11 may be used as a pre-charge switch during start-up of the switching converter 100.

In one embodiment, the pre-charge circuit 13 further comprises a gate control circuit 132 to control the pre-charge switch 131. As shown in FIG. 1, the gate control circuit 132 has a first terminal coupled to the input terminal 101, a second terminal coupled to a terminal 122 of the flying capacitor 12, and a third terminal coupled to the control terminal of the pre-charge switch 131. In one embodiment, the gate control circuit 132 is configured to ensure a voltage at the second terminal (e.g., the source terminal S) of the pre-charge switch 131 following a volatge at the control terminal (e.g., the gate terminal G) of the pre-charge switch 131, so as to charge the flying capacitor 12 by a charge current lcg. With the pre-charge circuit 13, the switching converter 100 could achieve precise control of the voltage Vc1 across the flying capactior 12, and could protect related switch devices from damage during start-up.

In one embodiment, the switching converter 100 further comprises an output filter 14. The output filter 14 is coupled between the switching circuit 11 and the output terminal 102 to provide the output voltage Vo at the output terminal 102 via low-pass filtering.

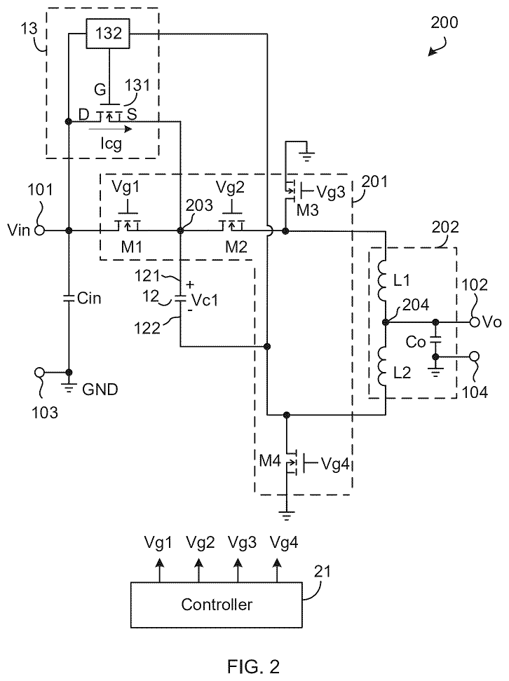

FIG. 2 schematically illustrates a switching converter 200 in accordance with an embodiment of the present invention. As shown in FIG. 2, the switching converter 200 comprises a switching circuit 201, an output filter 202, the flying capacitor 12, and the pre-charge circuit 13. In one embodiment, a capacitor Cin is coupled between the input terminal 101 and the input return terminal 103.

As shown in FIG. 2, the switching circuit 201 has switch devices M1-M4. One with ordinary skill in the art should understand that the switch devices M1-M4 may comprise MOSFET, Junction Field Effect Transistor (JFET), and other suitable transistors. The switch device M1 and the switch device M2 are coupled in series between the input terminal 101 and the output filter 202. In one embodiment, a drain terminal of the switch device M1 is coupled to the input terminal 101, a drain terminal of the switch device M2 is coupled to a source terminal of the switch device M1 to form a node 203, a source terminal of the switch device M2 is coupled to the output filter 202. The terminal 121 of the flying capacitor 12 is coupled to the node 203, while the terminal 122 of the flying capacitor 12 is coupled to the switch device M4, e.g., coupled to a drain terminal of the switch device M4 as shown in FIG. 2. In one embdoment, a drain terminal of the switch device M3 is coupled to the source terminal of the switch device M2, and a source terminal of the switch device M3 and a source terminal of the switch device M4 are coupled to the reference ground GND. In FIG. 2, the pre-charge switch 131 is coupled to the terminal 121 of the flying capacitor 12 to charge the flying capacitor 12 during start-up of the switching converter 200.

The output filter 202 shown in FIG. 2 comprises a magnetic device having a magnetic element L1 and a magnetic element L2. The magnetic elements L1-L2 may be two inductors or two windings of a transformer. In the embodiment shown in FIG. 2, one terminal of the magnetic element L1 is coupled to the drain terminal of the switch device M3 and the source terminal of the switch device M2, the other terminal of the magnetic element L1 is coupled to one terminal of the magnetic element L2 to form a node 204. The other terminal of the magnetic element L2 is coupled to the drain terminal of the switch device M4 and the terminal 122 of the flying capacitor 12. The node 204 is coupled to the output terminal 102 to provide the output voltage Vo. The output filter 202 shown in FIG. 2 further comprises a capacitor Co coupled between the output terminal 102 and the output return terminal 104.

In one embodiment, the switching converter 200 further comprises a controller 21. The controller 21 is configured to provide switching control signals Vg1-Vg4 to control the switch devices M1-M4 respectively. For example, the switching control signal Vg1 is configured to control the switch device M1, the switching control signal Vg2 is configured to control the switch device M2, the switching control signal Vg3 is configured to control the switch device M3, and the switching control signal Vg4 is configured to control the switch device M4.

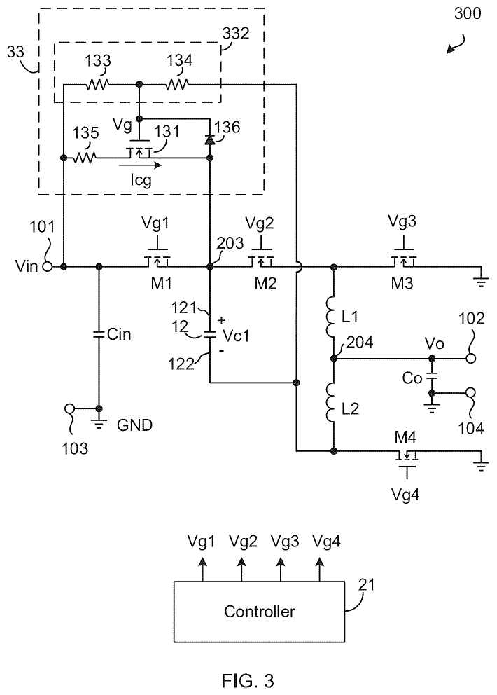

FIG. 3 schematically illustrates a switching converter 300 in accordance with an embodiment of the present invention. The switching converter 300 comprises a pre-charge circuit 33 coupled between the input terminal 101 and the flying capacitor 12. In one embodiment, the pre-charge circuit 33 has the pre-charge switch 131 and a gate control circuit 332. The gate control circuit 332 shown in FIG. 3 comprises a resistor 133 and a resistor 134 coupled in series between the input terminal 101 and the terminal 122 of the flying capacitor 12. A common node of the resistor 133 and the resistor 134 is coupled to the gate terminal of the pre-charge switch 131 to provide a gate control signal Vg to control the pre-charge switch 131. In one embodiment, the voltage Vc1 across the flying capacitor 12 during start-up of the switching converter 300 is determined by the input voltage Vin, the resistor 133 and the resistor 134.

In one embodiment, the pre-charge circuit 33 further comprises a resistor 135 coupled to the pre-charge switch 131 to limit the charge current lcg. The resistor 135 may be coupled between input terminal 101 and the pre-charge switch 131, or be coupled between the terminal 121 of the capacitor 12 and the pre-charge switch 131. In one embodiment, the pre-charge circuit 33 further comprises a diode 136 coupled between the gate terminal and the source terminal of the pre-charge switch 131 to protect the pre-charge switch 131. The diode 136 has an anode coupled to the source terminal of the pre-charge switch 131 and a cathode coupled to the gate terminal of the pre-charge switch 131.

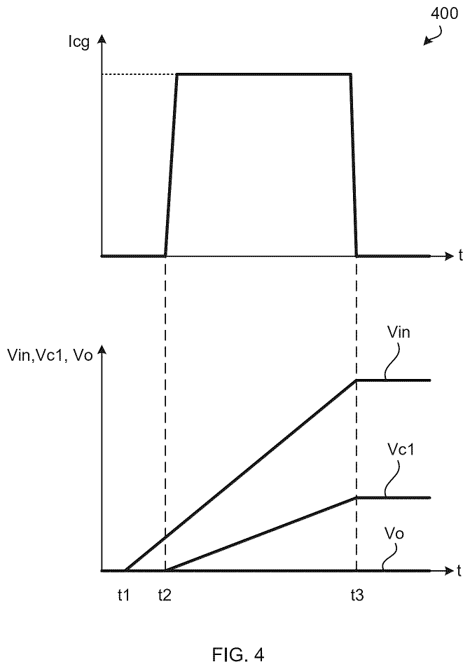

FIG. 4 illustrates a timing diagram 400 of the switching converter 300 shown in FIG. 3 in accordance with an embodiment of the present invention. From top to below, the timing diagram 400 shows the charge current lcg, the input voltage Vin, the voltage Vc1 across the flying capacitor 12, and the output voltage Vo.

Referring FIG. 4, at time t1, the input voltage Vin increases from an initial input voltage value (e.g., OV). When the input voltage Vin increases, the gate control signal Vg also goes up. At time t2, the gate control signal Vg forces the pre-charge switch 131 to partially turn on, which provides the charge current lcg to charge the flying capacitor 12. In one embodiment, the charge current lcg is determined by slew rate of the input voltage Vin. As a result, the voltage Vc1 across the flying capacitor 12 follows the input voltage Vin after time t2, e.g., the voltage Vc1 increases when the input voltage Vin increases. In one embodiment, the voltage Vc1 could be expressed as the following equation (1).

$$V c 1 = {V in}^{*} R 2 / ( R 1 + R 2 ) \qquad ( 1 )$$

R1 is the resistance of the resistor 133, and R2 is the resistance of the resistor 134.

In one embodiment, when the capacitor Co has a sufficient high capacitance, the output voltage Vo is almost zero volts during time t1 to t3 (that is during start-up of the switching converter 300) as shown in FIG. 4. At time t3, the input voltage Vin reaches the nominal input voltage value, start-up of the switching converter 300 is complete, and the charge current lcg decreases to zero amps to stop charging the flying capacitor 12.

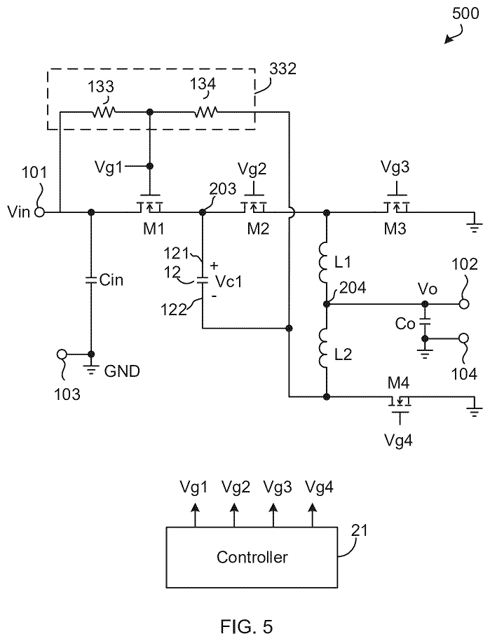

FIG. 5 schematically illustrates a switching converter 500 in accordance with an embodiment of the present invention. In the embodiment shown in FIG. 5, the switch device M1 which is coupled between the input terminal 101 and the flying capacitor 12 is used as the pre-charge switch during start-up of the switching converter 500. In one embodiment, the gate control circuit 332 is configured to partially turn on the switch device M1 during start-up of the switching converter 500 to charge the flying capacitor 12. And after start-up of the switching converter 500, the switch device M1 is turned on and off by the control signal Vg1 to convert the input voltage Vin to the output voltage Vo with the switch devices M2-M4.

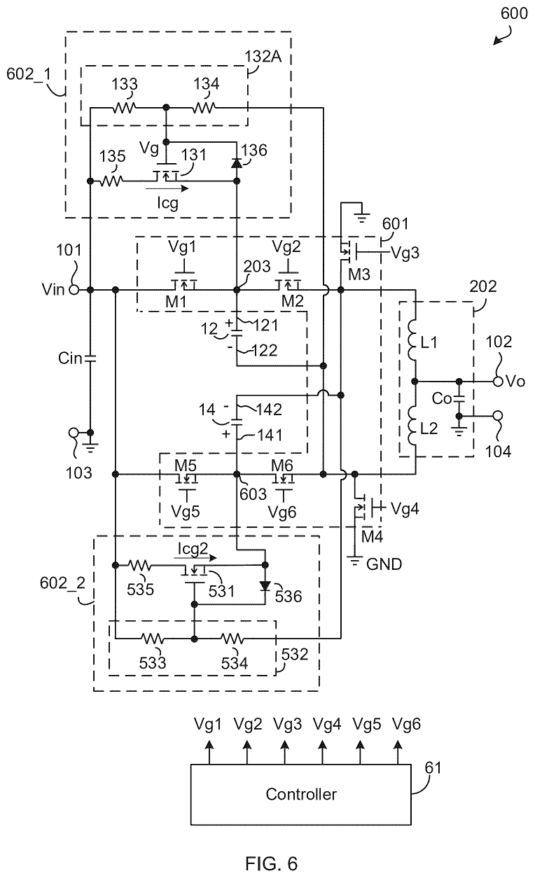

FIG. 6 schematically illustrates a switching converter 600 in accordance with an embodiment of the present invention. The switching converter 600 comprises a switching circuit 601, the flying capacitor 12, a flying capacitor 14, a pre-charge circuit having a first part 602_1 and a second part 602_2, and the output filter 202.

In addition of switch devices M1-M4, the switching circuit 601 further comprises a switch device M5 and a switch device M6 coupled in series between the input terminal 101 and the output filter 202. The switch devices M5-M6 may comprise MOSFET, JFET and other suitable transistors. A drain terminal of the switch device M5 is coupled to the input terminal 101, a source terminal the switch device M5 is coupled to a drain terminal of the switch device M6 to form a node 603, and a source terminal of the switch device M6 is coupled to the terminal 122 of the flying capacitor 12, the drain terminal of the switch device M4 and the output filter 202, e.g. the magnetic element L2 of the output filter 202.

The flying capacitor 14 has a terminal 141 and a terminal 142. The terminal 141 of the flying capacitor 14 is coupled to the node 603, the terminal 142 of the flying capacitor 14 is coupled to the source terminal of the switch device M2, the drain terminal of the switch device M3, and the output filter 202, e.g., the magnetic element L1 of the output filter 202. The first part 602_1 of the pre-charge circuit comprises the pre-charge switch 131 and the gate control circuit 332 to charge the flying capacitor 12 during start-up of the switching converter 600. And the second part 602_2 of the pre-charge circuit is configured to charge the flying capacitor 14 during start-up of the switching converter 600. The second part 602_2 of the pre-charge circuit 602 comprises a pre-charge switch 531 and a gate control circuit 532. The pre-charge switch 531 may comprise BJT, MOSFET, and other suitable transistors. The gate control circuit 532 is configured to partially turn on the pre-charge switch 531 to charge the flying capacitor 14 during start-up of the switching converter 600, and automatically stop charging the flying capacitor 14 based on the input voltage Vin, e.g., when the start-up of the switching converter 600 is complete. In one embodiment, the gate control circuit 532 comprises a resistor 533 and a resistor 534 coupled in series between the input terminal 101 and the terminal 142 of the flying capacitor 14, and a voltage at a source terminal of the pre-charge switch 531 is controlled to follow a voltage at a gate terminal of the pre-charge switch 531 during start-up of the switching converter 600. In one embodiment, the switch device M1 may be used as the pre-charge switch 131 to charge the flying capacitor 12 during start-up of the switching converter 600, and the switch device M5 may be used as the pre-charge switch 531 to charge the flying capacitor 14 during start-up of the switching converter 600.

In one embodiment, the second part 602_2 of the pre-charge circuit further comprises a resistor 535 coupled to the pre-charge switch 531 to limit a charge current lcg2, e.g., coupled between the input terminal 101 and the pre-charge switch 131, or coupled between the node 603 and the pre-charge switch 531. In one embodiment, the second part 602_2 of the pre-charge circuit further comprises a diode 536 coupled between the gate terminal and the source terminal of the pre-charge switch 531 to protect the pre-charge switch 531. The diode 536 has an anode coupled to the source terminal of the pre-charge switch 531 and a cathode coupled to the gate terminal of the pre-charge switch 531. In one embodiment, the switching converter 600 further comprises a controller 61. The controller 61 is configured to provide switching control signals Vg1-Vg6 to control the switch devices M1-M6 respectively.

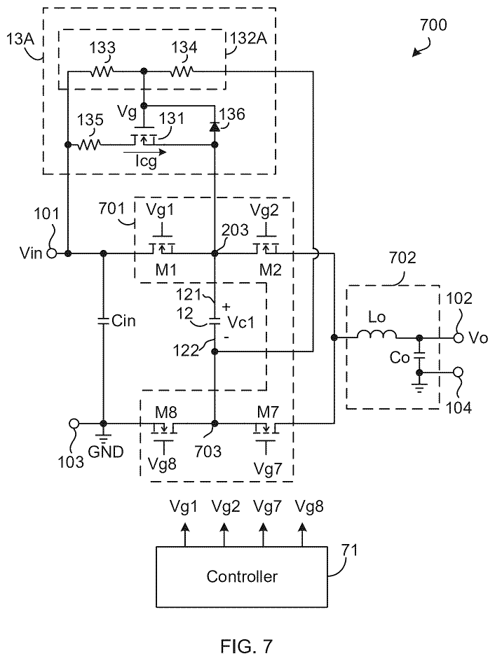

FIG. 7 schematically illustrates a switching converter 700 in accordance with an embodiment of the present invention. The switching converter 700 comprises a switching circuit 701, the flying capacitor 12, the pre-charge circuit 33, and an output filter 702. In the embodiment shown in FIG. 7, the output filter 702 comprises an inductor Lo and the capacitor Co. The inductor Lo has a first terminal coupled to the switching circuit 701, and a second terminal coupled to the capacitor Co and the output terminal 102 to provide the output voltage Vo.

Referring the FIG. 7, the switching circuit 701 comprises switch devices M1-M2, and M7-M8. The switch devices M7-M8 may comprise MOSFET, JFET and other suitable transistors. In one embodiment, a drain terminal of the switch device M7 is coupled to the source terminal of the switch device M2 and the output filter 702, e.g., the first terminal of the inductor Lo. A source terminal of the switch device M7 is coupled to a drain terminal of the switch device M8 to form a node 703, the source terminal of the switch device M8 is coupled to the reference ground GND. In the embodiment shown in FIG. 7, the terminal 122 of the flying capacitor 12 is further coupled to the node 703.

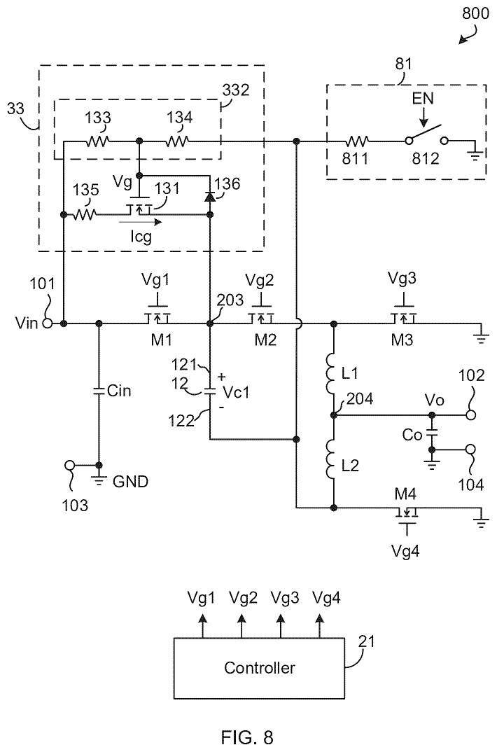

FIG. 8 schematically illustrates a switching converter 800 in accordance with an embodiment of the present invention. The switching converter 800 further comprises a pre-charge ON-OFF circuit 81. The pre-charge ON-OFF circuit 81 is coupled to the terminal 122 of the flying capacitor 12 to enable or disable the pre-charge circuit 33. As shown in FIG. 8, the pre-charge ON-OFF circuit 81 has a resistor 811 and a disable switch 812. In one embodiment, a first terminal of the disable switch 812 is coupled to the terminal 122 of the flying capacitor 12 via the resistor 811, a second terminal of the disable switch 812 is coupled to the reference ground GND, and a control terminal of the disable switch 812 is configured to receive a control signal EN. In another embodiment, the resistor 811 could be coupled between the second terminal of the disable switch 812 and the reference ground GND. When the disable switch 812 is turned ON by the control signal EN, the pre-charge circuit 33 is disabled, such that the pre-charge circuit 33 stops charging the flying capacitor 12. One with ordinary skill in the art should understand that the disable switch 812 may comprise MOSFET, JFET and other suitable transistors. One with ordinary skill in the art should also understand that the circuit structure shown in FIG. 8 is for illustrated purpose and not intended to limit the scope of the invention. For example, the switching circuit of the switching converter 800 may have different topology other than that shown in FIG. 8.

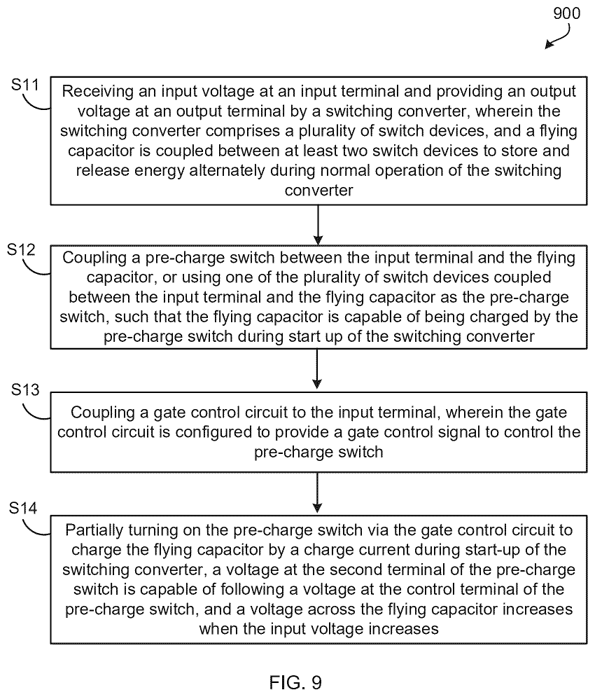

FIG. 9 illustrates a pre-charge method 900 of a switching converter in accordance with an embodiment of the present invention. The pre-charge method 900 has steps S11-S14.

At the step S11, receiving an input voltage at an input terminal and providing an output voltage at an output terminal by a switching converter, wherein the switching converter comprises a plurality of switch devices, and a flying capacitor is coupled between at least two switch devices to store and release energy alternately during normal operation of the switching converter.

At the step S12, coupling a pre-charge switch between the input terminal and the flying capacitor, or using one of the plurality of switch devices coupled between the input terminal and the flying capacitor as the pre-charge switch, such that the flying capacitor is capable of being charged by the pre-charge switch during start-up of the switching converter. In one embodiment, the pre-charge switch has a first terminal coupled to the input terminal, a second terminal and a control terminal.

At the step S13, coupling a gate control circuit to the input terminal, wherein the gate control circuit is configured to provide a gate control signal to control the pre-charge switch.

At the step S14, partially turning on the pre-charge switch via the gate control circuit to charge the flying capacitor by a charging current during start-up of the switching comverter, a voltage at the second terminal of the pre-charge switch is capable of following a voltage at the control terminal of the pre-charge switch, and a voltage across the flying capacitor increases when the input voltage increases. In one embodiment, the charge current is related to rising slew rate of the input voltage.

In one embodiment, the pre-charge method 900 may further comprises coupling a pre-charge ON-OFF circuit to a second terminal of the flying capacitor, and turning on a disable switch of the pre-charge ON-OFF to stop charging the flying capacitor after the start-up is complete.

Note that in the pre-charge method 900 described above, the box functions may also be implemented with different order as shown in FIG. 9. Two successive box functions may be executed meanwhile, or sometimes the box functions may be executed in a reverse order.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A switching converter, comprising:
an input terminal configured to receive an input voltage;
an output terminal configured to provide an output voltage;
a switching circuit having a first switch device, a second switch device, and a third switch device, wherein a first terminal of the first switch device is coupled to the input terminal, and a first terminal of the second switch device is coupled to a second terminal of the first switch device;
a first flying capacitor having a first terminal and a second terminal, wherein the first terminal of the first flying capacitor is coupled to the first terminal of the second switch device and the second terminal of the first switch device, and the second terminal of the flying capacitor is coupled to a first terminal of the third switch device;
an output filter coupled between the switching circuit and the output terminal, wherein the output filter comprises a magnetic device coupled to a second terminal of the second switch device; and
a pre-charge circuit coupled to the input terminal, and is configured to charge the first flying capacitor via a first pre-charge switch during start-up of the switching converter, wherein the first pre-charge switch has a first terminal coupled to the input terminal, a second terminal and a control terminal, and wherein the pre-charge circuit is configured to get a voltage at the second terminal of the first pre-charge switch to follow a voltage at the control terminal of the first pre-charge switch during start-up of the switching converter.

2. The switching converter of claim 1, wherein the first pre-charge circuit is configured to automatically stop charging the first flying capacitor based on the input voltage after the start-up is complete.

3. The switching converter of claim 1, wherein the pre-charge circuit comprises:
a first resistor having a first terminal and a second terminal, wherein the first terminal of the first resistor is coupled to the input terminal, and the second terminal of the first resistor is coupled to the control terminal of the first pre-charge switch; and
a second resistor having a first terminal and a second terminal, wherein the first terminal of the second resistor is coupled to the second terminal of the first resistor and the control terminal of the first pre-charge switch; wherein
the first terminal of the first flying capacitor is further coupled to the second terminal of the first pre-charge switch and the second terminal of the first flying capacitor is further coupled to the second terminal of the second resistor.

4. The switching converter of claim 1, further comprising:
a pre-charge ON-OFF circuit having a disable switch coupled to the second terminal of the first flying capacitor, wherein when the disable switch is turned on, the pre-charge ON-OFF circuit is configured to disable the first pre-charge circuit, such that the first pre-charge circuit stops charging the first flying capacitor.

5. The switching converter of claim 1, further comprising:
a second flying capacitor, having a first terminal and a second terminal; wherein
the switching circuit further comprises:
a fourth switch device, wherein a first terminal of the fourth switch device is coupled to the input terminal, and a second terminal of the fourth switch device is coupled to the first terminal of the second flying capacitor;
a fifth switch device, wherein a first terminal of the fifth switch device is coupled to the second terminal of the fourth switch device and the first terminal of the second flying capacitor, a second terminal of the fifth switch device is coupled to the second terminal of the first flying capacitor and the first terminal of the third switch device; and
a sixth switch device, wherein a first terminal of the sixth switch device is coupled to the second terminal of the second flying capacitor and the second terminal of the second switch device; and wherein
the pre-charge circuit is configured to charge the second flying capacitor via a second pre-charge switch during start-up of the switching converter, wherein the second pre-charge switch has a first terminal coupled to the input terminal, a second terminal and a control terminal, and wherein the pre-charge circuit is configured to get a voltage at the second terminal of the second pre-charge switch to follow a voltage at the control terminal of the second pre-charge switch during start-up of the switching converter.

6. The switching converter of claim 1, wherein the switching circuit further comprises:
a fourth switch device, wherein a first terminal of the fourth switch device is coupled to the second terminal of the second switch device, and a second terminal of the fourth switch device is coupled to the first terminal of the third switch device and the first terminal of the first flying capacitor.

7. The switching converter of claim 1, wherein the switching circuit further comprises:
a fourth switch device, wherein a first terminal of the fourth switch device is coupled to the second terminal of the second switch device, and a second terminal of the fourth switch device is coupled to a second terminal of the third switch device and a reference ground.

8. A switching converter, comprising:
an input terminal configured to receive an input voltage;
an output terminal configured to provide an output voltage;
a switching circuit having a plurality of switch devices;
a flying capacitor coupled between at least two of the plurality of switch devices; and
a pre-charge circuit configured to charge the flying capacitor via partially turning on a pre-charge switch during start-up of the switching converter, wherein the pre-charge switch has a first terminal coupled to the input terminal, a second terminal and a control terminal; wherein
during start-up of the switching converter, a voltage at the second terminal of the pre-charge switch is controlled to follow a voltage at the control terminal of the pre-charge switch, and a voltage across the flying capacitor is controlled to increase when the input voltage increases.

9. The switching converter of claim 8, wherein the pre-charge circuit comprises:
a gate control circuit having a first terminal, a second terminal and a third terminal, wherein the first terminal of the gate control circuit is coupled to the input terminal, and the third terminal of the gate control circuit is coupled to the control terminal of the the pre-charge switch to control the pre-charge switch.

10. The switching converter of claim 9, wherein a first terminal of the flying capacitor is coupled to the second terminal of the pre-charge switch, and a second terminal of the flying capacitor is coupled to the second terminal of the gate control circuit.

11. The switching converter of claim 8, wherein the pre-charge circuit comprises:
a first resistor having a first terminal and a second terminal, wherein the first terminal of the first resistor is coupled to the input terminal, and the second terminal of the first resistor is coupled to the control terminal of the pre-charge switch; and
a second resistor having a first terminal and a second terminal, wherein the first terminal of the second resistor is coupled to the second terminal of the first resistor and the control terminal of the pre-charge switch; wherein
a first terminal of the flying capacitor is coupled to the second terminal of the pre-charge switch and a second terminal of the flying capacitor is coupled to the second terminal of the second resistor.

12. The switching converter of claim 8, wherein the pre-charge circuit comprises:
a resistor coupled to the second terminal or a first terminal of the pre-charge switch to limit a charge current provided to a first terminal of the flying capacitor.

13. The switching converter of claim 8, wherein the pre-charge circuit comprises:
a diode having an anode and a cathode, wherein the anode is coupled to the second terminal of the pre-charge switch, and the cathode is coupled to the control terminal of the pre-charge switch.

14. The switching converter of claim 8, wherein one of the plurality of switch devices which is coupled between the input terminal and the flying capacitor is configured to be used as the pre-charge switch during start-up of the switching converter.

15. The switching converter of claim 8, wherein the flying capacitor has a first terminal and a second terminal, the first terminal of the flying capacitor is coupled to the second terminal of the pre-charge switch, and the switching converter further comprising:
a pre-charge ON-OFF circuit having a disable switch coupled to the second terminal of the flying capacitor, wherein when the disable switch is turned on, the pre-charge ON-OFF circuit is configured to disable the pre-charge circuit, such that the pre-charge circuit stops charging the flying capacitor.

16. The switching converter of claim 8, wherein the plurality of switch devices comprise:
a first switch device, wherein a first terminal of the first switch device is coupled to the input terminal, and a second terminal of the first switch device is coupled to a first terminal of the flying capacitor;
a second switch device, wherein a first terminal of the second switch device is coupled to the second terminal of the first switch device and the first terminal of the flying capacitor;
a third switch device, wherein a first terminal of the third switch device is coupled to the second terminal of the second switch device, and a second terminal of the third switch device is coupled to a reference ground; and
a fourth switch device, wherein a first terminal of the fourth switch device is coupled to a second terminal of the flying capacitor, and a second terminal of the fourth switch device is coupled to the reference ground.

17. The switching converter of claim 8, wherein the plurality of switch devices comprise:
a first switch device, wherein a first terminal of the first switch device is coupled to the input terminal, and a second terminal of the first switch device is coupled to a first terminal of the flying capacitor;
a second switch device, wherein a first terminal of the second switch device is coupled to the second terminal of the first switch device and the first terminal of the flying capacitor;
a third switch device, wherein a first terminal of the third switch device is coupled to the second terminal of the second switch device, and a second terminal of the third switch device is coupled to a second terminal of the flying capacitor; and
a fourth switch device, wherein a first terminal of the fourth switch device is coupled to the second terminal of the third switch device and the second terminal of the flying capacitor, and a second terminal of the fourth switch device is coupled to a reference ground.

18. A pre-charge method for a switching converter, comprising:
receiving an input voltage at an input terminal and providing an output voltage at an output terminal;
coupling a pre-charge switch between the input terminal and a first terminal of a flying capacitor such that the flying capacitor is capable of being charged by the pre-charge switch during start-up of the switching converter, wherein the pre-charge switch has a first terminal coupled to the input terminal, a second terminal and a control terminal;
coupling a gate control circuit to the input terminal, wherein the gate control circuit is configured to provide a gate control signal to control the pre-charge switch; and
partially turning on the pre-charge switch via the gate control circuit to charge the flying capacitor during start-up of the switching converter, such that a voltage at the second terminal of the pre-charge switch is capable of following a voltage at the control terminal of the pre-charge switch.

19. The pre-charge method of claim 18, wherein a voltage across the flying capacitor is controlled to increase when the input voltage increases during start-up of the switching converter.

20. The pre-charge method of claim 18, further comprising:
coupling a pre-charge ON-OFF circuit to a second terminal of the flying capacitor, and turning on a disable switch of the pre-charge ON-OFF circuit to stop charging the flying capacitor after the start-up is complete.
